(19) United States
(12) Patent Application Publication
(10) Pub. No.: US 2024/0250378 A1
(43) Pub. Date: Jul. 25, 2024

(54) SECONDARY BATTERY

(71) Applicant: LG ENERGY SOLUTION, LTD., Seoul (KR)

(72) Inventors: Yong Ho LEE, Daejeon (KR); Seung Jin KONG, Daejeon (KR); JIn Kyu LEE, Daejejon (KR)

(21) Appl. No.: 18/561,694

(22) PCT Filed: Apr. 14, 2023
(86) PCT No.: PCT/KR2023/005129

§ 371 Date: Nov. 16, 2023

(30) Foreign Application Priority Data
Apr. 18, 2022 (KR) 10-2022-0047720
Dec. 27, 2022 (KR) 10-2022-0185543

(51) Int. Cl. H01M 50/383; H01M 10/613; H01M 10/6556; H01M 50/30; H01M 50/367; H01M 50/655

(52) U.S. Cl. CPC H01M 50/383; H01M 10/613; H01M 10/6556; H01M 50/367; H01M 50/394; H01M 50/655

(57) ABSTRACT

Disclosed herein relates to a secondary battery, which in one example includes a housing made of metal, at least one battery cell within the housing, and a coolant, wherein the housing includes an inner surface facing the at least one battery cell and an outer surface spaced apart from the inner surface, and wherein the coolant is stored in a hollow portion formed between the inner surface and the outer surface.

### CROSS-REFERENCE TO RELATED APPLICATIONS

This application is a National Phase entry pursuant to 35 U.S.C. § 371 of International Application No. PCT/KR2023/005129, filed on Apr. 14, 2023, and claims the benefit of and priority to Korean Patent Application No. 10-2022-0047720, filed on Apr. 18, 2022 and Korean Patent Application No. 10-2022-0185543, filed on Dec. 27, 2022, the disclosures of which are incorporated by reference in their entirety for all purposes as if fully set forth herein.

### TECHNICAL FIELD

The present disclosure relates to a secondary battery capable of suppressing a heat propagation phenomenon that causes other secondary batteries in the vicinity to continuously overheat in the event of a thermal runaway.

### BACKGROUND

Unlike primary batteries, secondary batteries can be recharged, and they have been heavily researched and developed in recent years due to their potential for miniaturization and large capacity. The demand for secondary batteries as an energy source is increasing rapidly due to the technological development and increasing demand for mobile devices, and due to electric vehicles and energy storage systems, which are emerging in response to the need for environmental protection.

Secondary batteries are categorized into coin-type cells, cylindrical cells, prismatic cells, and pouch-type cells based on the shape of the battery case. In a secondary battery, an electrode assembly mounted inside the battery case is a chargeable/dischargeable power generator consisting of a laminated structure of electrodes and separators.

Since secondary batteries are required to be used continuously for a long period of time, it is necessary to effectively control the heat generated during the charging and discharging process. In addition, if the secondary battery is overcharged or an external short circuit occurs and an overcurrent is applied, the increase in current causes the temperature to rise, and the increase in temperature causes the current to increase again, resulting in a feedback chain reaction that eventually leads to the catastrophic condition of thermal runaway.

In addition, if the secondary batteries are grouped together in the form of modules or packs, the thermal propagation phenomenon occurs, in which the thermal runaway of one secondary battery continuously overheats other secondary batteries in the vicinity. Furthermore, there is a high risk of fire due to flammable gases emitted from overheated secondary batteries and due to ignition sources such as heated electrodes, so it is necessary to suppress this ignition risk.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

### Technical Problem

The present disclosure aims to provide a secondary battery that can effectively suppress and prevent the phenomenon of heat propagation due to thermal runaway generated in the secondary battery.

However, the technical problems that the present disclosure seeks to address are not limited to those described above, and other problems not mentioned will be apparent to those of ordinary skill in the art from the following description of the disclosure.

### Technical Solution

The present disclosure relates to a secondary battery, which in one example includes a metal housing; at least one battery cell within the housing; and a coolant, wherein the housing includes an inner surface facing the at least one battery cell and an outer surface spaced apart from the inner surface, and wherein the coolant is stored in a hollow portion formed between the inner surface and the outer surface.

In one exemplary embodiment of the present disclosure, the hollow portion may be provided with a pair of openings on both sides of the housing.

In addition, the secondar battery may further comprise: a pair of side adapters on both sides of the housing that seal the pair of openings of the hollow portion.

Here, the hollow portion may be provided in plural, each of the side adapters includes a groove for coupling to the inner and outer surface of the housing, and the openings of the hollow portions in one side of the housing communicate with each other within the groove.

Furthermore, each of the side adapters may include a spigot hole exposing part of the openings of the hollow portions in one side of the housing to allow for spigotting from the outside, and the spigot hole may be sealed by a stopper.

The stopper may be made of a material having a melting point lower than that of a material of the housing.

In addition, the spigot hole may be disposed in the upper part of the housing.

In addition, the secondary battery of the present disclosure may further include: a side cap coupled to the side adapter, and forming an interior space in which an electrode lead of the at least one battery cell is located; and a busbar disposed inside the side cap and electrically connected to the electrode lead, a part of which is exposed through an opening in the side cap forming an electrode terminal.

According to an exemplary embodiment of the present disclosure, the busbar may include a venting hole formed on the electrode terminal, and wherein, when the stopper melts, the coolant and/or water vapor stored in the hollow portion of the housing may pass through the spigot hole and may be discharged to the venting hole.

Depending on the exemplary embodiment, a filter may be installed in the venting hole to filter out particles exceeding a pre-determined size.

Meanwhile, according to another exemplary embodiment of the present disclosure, the secondary battery may further includes: a guide body disposed on an interior of the side cap to face the busbar, wherein the guide body may direct the flow of gases generated by the at least one battery cell, the coolant and/or water vapor discharged through the spigot hole to the venting hole.

The guide body may comprise a plurality of guide plates that divide the flow of gases generated in the at least one battery cell, coolant and/or water vapor discharged through the spigot hole into a plurality of branches.

In addition, the guide body may be disposed closely against the inner surface of the side adapter, and may be provided with a through hole corresponding to the spigot hole of the side adapter.

Furthermore, a filter may be installed in the venting hole to filter out particles exceeding a pre-determined size, and the guide body may comprise a storage space formed in an inlet region of the filter.

In addition, the storage space may be disposed downstream of the spigot hole.

### Advantageous Effects

According to the secondary battery of the present disclosure with the above configuration, the coolant stored inside the housing can quickly absorb and dissipate heat in an environment with high temperature rise such as rapid charging during normal use, thereby suppressing the occurrence of thermal runaway and maintaining performance and lifespan without high temperature rise.

In addition, the present disclosure can suppress heat propagation by the insulating effect of the coolant stored inside the housing when thermal runaway occurs in the secondary battery, as well as greatly reducing the risk of fire by cooling the ignition sources such as flammable gases emitted from the overheated battery cells and heated electrodes as the low-melting point stopper sealing the coolant melts and is emitted as coolant and/or water vapor, thereby suppressing the flame.

Furthermore, by installing a filter that filters out particles exceeding a certain size in the venting hole provided in the secondary battery, the present disclosure can effectively suppress the risk of an external fire caused by an ignition source of high temperature particles.

However, the technical effects of the present disclosure are not limited to those described above, and other effects not mentioned will be apparent to one of ordinary skill in the art from the following description of the disclosure.

### BRIEF DESCRIPTION OF THE DRAWINGS

The accompanying drawings illustrate exemplary embodiments of the present disclosure and, together with the following detailed description, serve to provide further understanding of the technical spirit of the present disclosure. Therefore, the present disclosure is not to be construed as being limited to the drawings.

FIG. 1 is a perspective view of a secondary battery according to a first embodiment of the present disclosure.

FIG. 2 is an exploded perspective view of the secondary battery in FIG. 1.

FIG. 3 is a detailed diagram of the housing of a secondary battery.

FIG. 4 is a diagram of the structure in which a side adapter is coupled to a housing of a secondary battery.

FIGS. 5 and 6 are diagrams illustrating a state in which a housing with side adapters coupled is filled with coolant and sealed.

FIG. 7 is a diagram illustrating a state in which a side cap and a busbar are coupled to a side of a case.

FIG. 8 is a diagram illustrating a state in which a coolant stored in a housing is emitted to a venting hole with high-temperature gases.

FIG. 9 is an exploded perspective view of a secondary battery according to a second embodiment of the present disclosure.

FIG. 10 is a front view illustrating a mounting structure of a guide body.

FIG. 11 is a cross-sectional view across a venting hole and a guide body.

FIG. 12 is a diagram illustrating a state in which a coolant stored in the housing is induced to be emitted to a venting hole along with high-temperature gases in a second embodiment of the present disclosure.

### DETAILED DESCRIPTION

While the present disclosure may be variously changed and have various embodiments, specific embodiments will be described in detail below.

However, it is to be understood that the present disclosure is not limited to the specific embodiments described herein but includes all modifications, equivalents, and substitutions included in the spirit and the scope of the present disclosure.

In this application, it should be understood that terms such as “include” or “have” are intended to indicate the presence of a feature, number, step, operation, component, part, or a combination thereof described on the specification, and they do not preclude the possibility of the presence or addition of one or more other features or numbers, steps, operations, components, parts or combinations thereof.

In addition, in this application, when a portion such as a layer, a film, an area, a plate, and the like are referred to as being “on” another portion, this includes not only the case where the portion is “directly on” another portion but also the case where still another portion is interposed therebetween. On the other hand, when a portion such as a layer, a film, an area, a plate, and the like are referred to as being “under” another portion, this includes not only the case where the portion is “directly under” another portion but also the case where still another portion is interposed therebetween. In addition, to be disposed “on” in the present application may include the case of being disposed at the bottom as well as the top.

The present disclosure relates to a secondary battery, and in one example, includes a metal housing; and at least one battery cell housed within the housing; wherein the housing includes a coolant stored in a hollow portion formed between an inner surface facing the battery cell and an outer surface spaced apart with respect to the inner surface. In other words, the present disclosure includes a configuration in which the housing itself stores the coolant.

According to the secondary battery of the present disclosure with the above configuration, the coolant stored inside the housing can quickly absorb and dissipate heat in an environment with high temperature rise such as rapid charging during normal use, thereby suppressing the occurrence of thermal runaway and maintaining performance and lifespan without high temperature rise.

In addition, the present disclosure can suppress heat propagation by the insulating effect of the coolant stored inside the housing when thermal runaway occurs in the secondary battery, as well as greatly reducing the risk of fire by cooling the ignition sources such as flammable gases emitted from the overheated battery cells and heating electrodes as the low-melting point stopper sealing the coolant melts and is emitted as coolant and/or water vapor, thereby suppressing the flame.

### MODE FOR CARRYING OUT THE INVENTION

Hereinafter, specific embodiments of the present disclosure will be described in detail with reference to the accompanying drawings. In the following description, the directions of front, back, up, down, left, right, and center, which designate relative positions, are intended to aid in the understanding of the invention, and use the directions shown in the drawings unless otherwise specified.

### First Embodiment

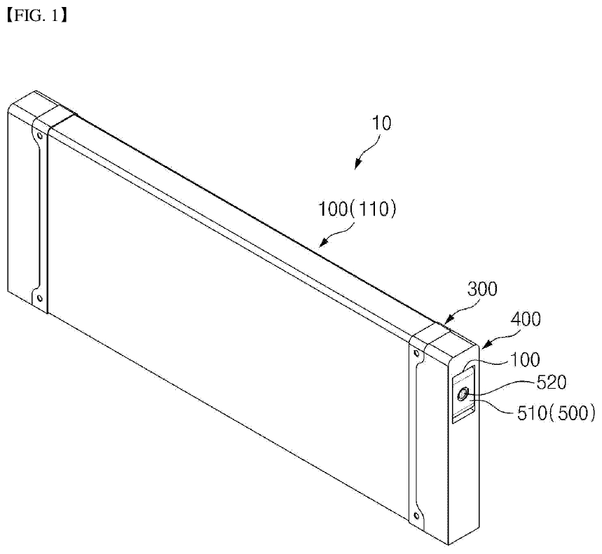

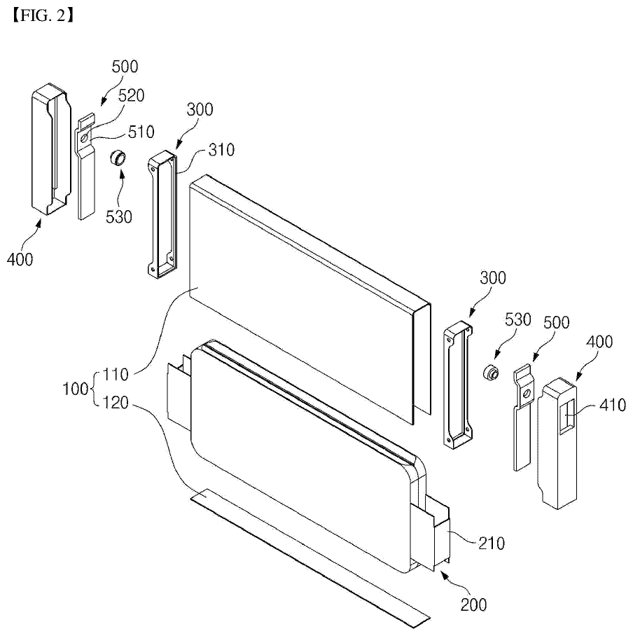

FIG. 1 is a perspective view of a secondary battery 10 according to a first embodiment of the present disclosure, and FIG. 2 is an exploded perspective view of the secondary battery 10 of FIG. 1.

As shown in the accompanying drawings, the secondary battery 10 of the present disclosure includes a housing 100 made of metal, and at least one battery cell 200 housed within the housing 100. As one example, in the illustrated exemplary embodiment, the battery cell 200 is a pouch-type battery cell 200 with bidirectional terminals, and two pouch-type battery cells 200 are housed within the housing 100.

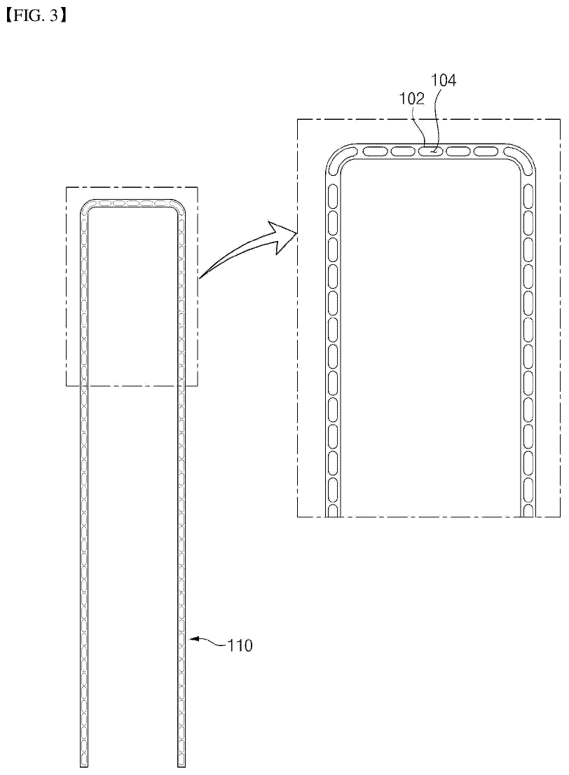

FIG. 3 is a detailed diagram of a housing 100 of the secondary battery 10, wherein the housing 100 has a hollow portion 102 formed between an inner surface facing the battery cell 200 and an outer surface spaced apart with respect to the inner surface, and a coolant is stored in the hollow portion 102 provided in the thickness of the housing 100.

The housing 100 may be integrally formed with the hollow portion 102 by extrusion molding a metal material such as aluminum or stainless steel, or alloys thereof. In the exemplary embodiment shown, the housing 100 consists of a main housing 110 having a cross-sectional shape of a lowercase “n” of the English alphabet and a bottom plate 120 coupled to the opening at the lower part, considering the ease of storage of the battery cell 200, the cost of extrusion molding, etc.

In addition, the hollow portion 102 has an open entrance/exit (e.g., opening) 104 on both sides of the housing 100. This is in consideration of the orientation of the continuous extrusion molding of the main housing 110, and also to ensure that the hollow portion 102 is well supplied with coolant.

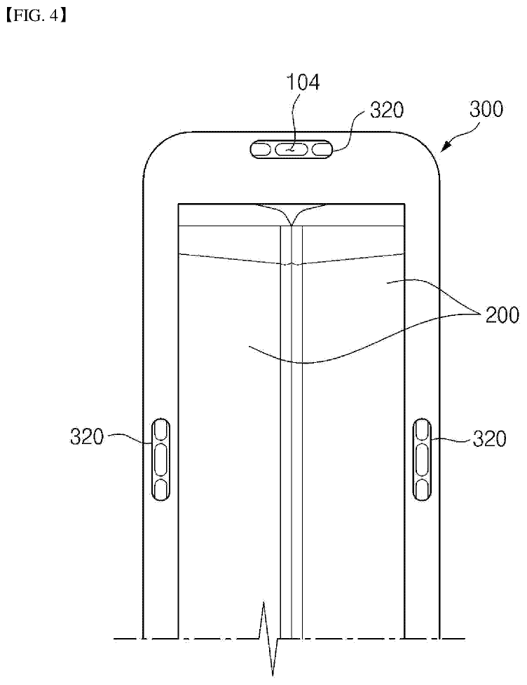

Since the hollow portion 102 of the housing 100 is open on both sides, a separate sealing structure is required to store the coolant. For sealing the coolant, in the present disclosure, side adapters 300 that seal the entrance/exit (e.g., opening) 104 of the hollow portion 102 is coupled to both sides of the housing 100 against the outside. FIG. 4 illustrates the structure of the side adapters 300 coupled to the housing 100.

The side adapter 300 has grooves 310 that bind the inner and outer surfaces of the housing 100. The edges of the housing 100 are inserted into the grooves 310 to form a mutual binding, and a solid seal is formed by welding or the like. Furthermore, the entrance/exit (e.g., openings) 104 of the hollow portion 102 disposed in the grooves 310 of the side adapter 300 communicate with each other in the grooves 310. That is, the bottom surfaces of the grooves 310 are spaced apart to form a space with respect to the entrance/exit (e.g., openings) 104 of the hollow portion 102, and accordingly, the side adapter 300 may allow the coolant to mutually flow within the grooves 310 while sealing the coolant in the hollow portion 102 from leaking to the outside.

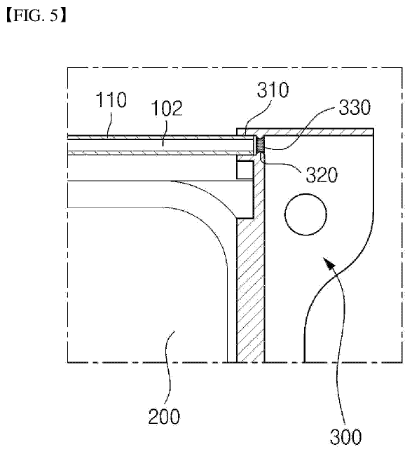

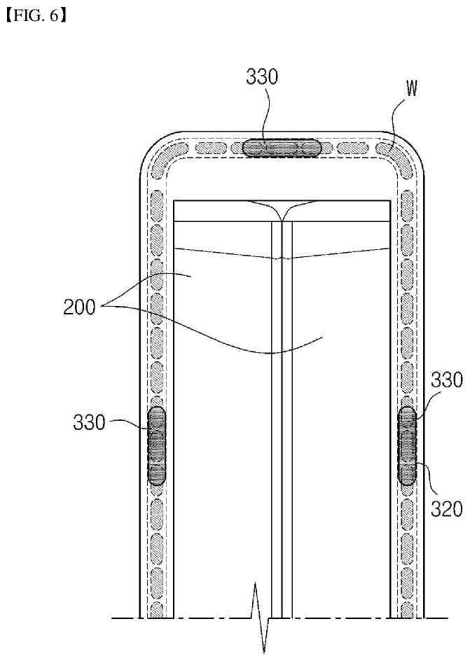

Furthermore, the side adapter 300 has a spigot hole 320 exposing a part of the entrance/exit (e.g., openings) 104 of the hollow portion 102 to allow spigot from the outside, and the spigot hole 320 is sealed by a stopper 330. FIGS. 5 and 6 are diagrams illustrating a state in which a housing 100 with side adapters 300 coupled is filled with coolant W and sealed. FIG. 5 shows a side cross-sectional view, and FIG. 6 shows a state in which the spigot hole 320 is sealed by the stopper 330.

The spigot hole 320 is formed as a structure that penetrates the bottom surface of the groove 310. Inside the groove 310, the entrance/exit (e.g., openings) 104 of the hollow portion 102 are interconnected, so that the coolant W is injected into all of the hollow portions 102, even if the coolant W is injected into the locally open spigot hole 320. When the injection of the coolant W is completed, the spigot hole 320 is sealed with a stopper 330 to complete the seal. Here, in consideration of deflation and the like, it may be advantageous to place the spigot hole 320 in the upper part of the housing 100 to facilitate the injection of the coolant W.

In addition, the stopper 330 is made of a material that has a relatively low melting point compared to the housing 100. The stopper 330 may be made of a variety of materials, such as metal, non-metal, synthetic resin, rubber, and the like. It is also possible to manufacture a separate stopper 330 and couple it to the spigot hole 320, as well as to close the spigot hole 320 by techniques such as brazing or soldering.

The secondary battery 10 of the present disclosure contributes to suppressing the occurrence of thermal runaway and maintaining performance and lifespan by allowing the coolant W stored in the housing 100 to quickly absorb and dissipate heat in an environment with a high temperature rise, such as during normal rapid charging.

In addition, in the event of a thermal runaway phenomenon in the secondary battery 10, the present disclosure can suppress heat propagation to the surroundings by the insulating effect of the coolant W stored inside the housing 100, as well as greatly reducing the risk of fire by cooling the ignition sources such as flammable gases emitted from the overheated battery cell 200 and heated electrodes as the low-melting point stopper 330 sealing the coolant melts and is emitted as coolant and/or water vapor, thereby suppressing the flame.

In other words, in the present disclosure, the coolant stored in the housing 100 greatly improves the safety of the secondary battery 10 by performing various functions ranging from insulation, heat absorption, heat dissipation, cooling, and fire extinguishing.

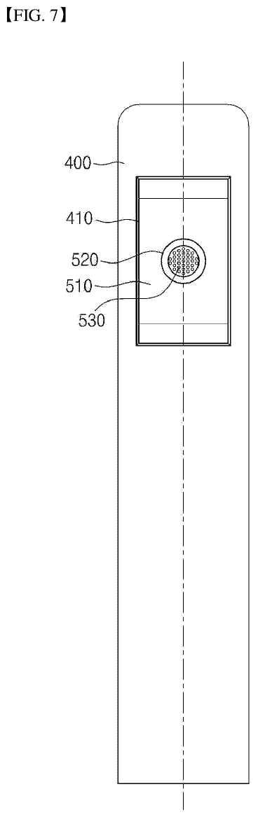

Additionally, the secondary battery 10 of the present disclosure may include a side cap 400 that couples to the side adapter 300 and forms an interior space in which the electrode lead 210 of the battery cell 200 is located, and a busbar 500 disposed on the interior of the side cap 400 and electrically connected to the electrode leads 210 of the battery cell 200. Here, a part of the busbar 500 exposed through an incision 410 provided in the side cap 400 may form an electrode terminal 510. FIG. 7 is a diagram illustrating a state in which a side cap and a busbar are coupled to a side of a housing.

The location of the incision 410 may be disposed generally above the center of the height of the secondary battery 10, that is, at the upper part of the secondary battery 10. This is to allow for the convenience of electrical connections to the busbar 500 exposed by the incision 410, while also being a suitable location to allow water vapor vaporized by the coolant W stored inside the housing 100 to be emitted from the secondary battery 10.

Furthermore, according to an exemplary embodiment of the present disclosure, the busbar 500 may be provided with a venting hole 520 formed on the electrode terminal 510. Accordingly, when the battery cell 200 overheats and melts the stopper 330 blocking the spigot hole 320, coolant and/or water vapor stored in the hollow portion 102 of the housing 100 passes through the spigot hole 320 to cool the high-temperature gases generated by the battery cell 200 and the ignition source such as the heated electrode, and is then discharged into the venting hole 520.

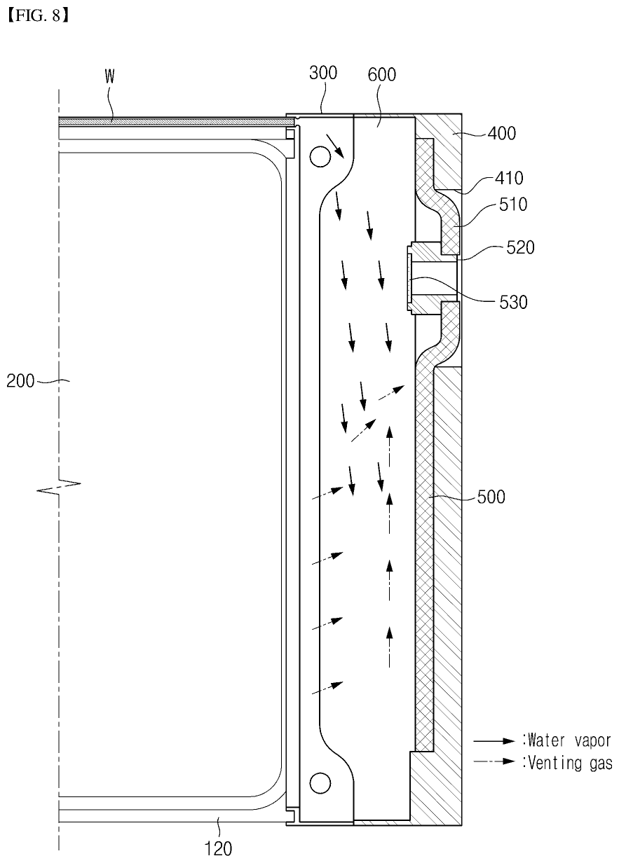

FIG. 8 is a diagram illustrating a state in which a coolant W stored in a housing 100 is discharged into a venting hole 520 with high-temperature gases (venting gas). The stopper 330, which was blocking the spigot hole 320 disposed on the upper part of the housing 100, is melted and disappeared by the heat of the overheated battery cell 200, so that water vapor is discharged from the spigot hole 320 and venting gas is discharged from the overheated battery cell 200.

In the case of the pouch-type battery cell 200, the area where the seal is relatively weak is the part where the electrode leads 210 protrude out, and referring to FIG. 2, the electrode leads 210 are located on the lower side of the battery cell 200 relative to the spigot hole 320. Accordingly, the water vapor discharged from the upper side of the housing 100 and the venting gas discharged from the lower side of the battery cell 200 collide in the middle, causing mutual heat exchange, and the temperature of the venting gas drops, and the water vapor and the venting gas with the adjusted temperature are discharged to the outside through the venting hole 520. In this way, the internal pressure of the housing 100 is relieved by proper ventilation through the venting hole 520, and the structural collapse of the secondary battery 10 is prevented.

In addition, depending on the exemplary embodiment, the venting hole 520 may be equipped with a filter 530 that filters out particles exceeding a certain size. The filter 530 may effectively suppress the risk of an external fire that may be caused by an ignition source of hot particles from the overheated battery cell 200 escaping to the outside.

### Second Embodiment

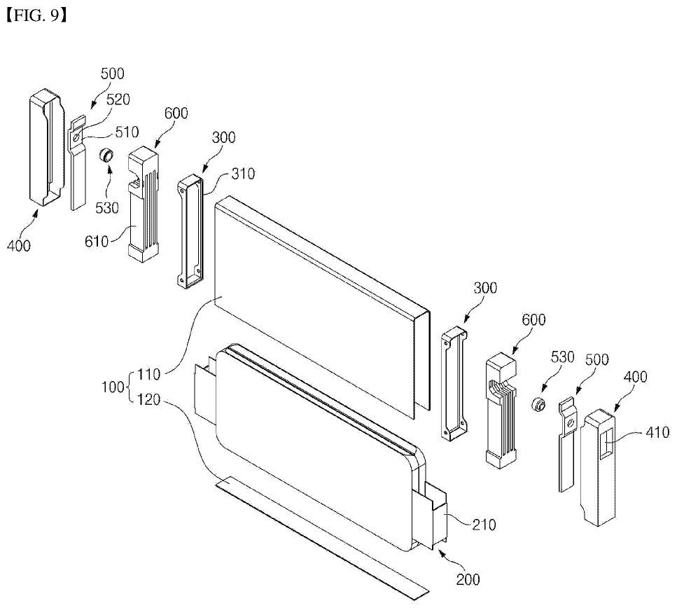

FIG. 9 is an exploded perspective view of a secondary battery 10 according to a second embodiment of the present disclosure, wherein the second embodiment of the present disclosure further includes a guide body 600 disposed to face the busbar 500 on the interior of the side cap 400. The guide body 600 serves to direct the flow of gases generated by the battery cell 200 and coolant and/or water vapor discharged through the spigot hole 320 to the venting hole 520.

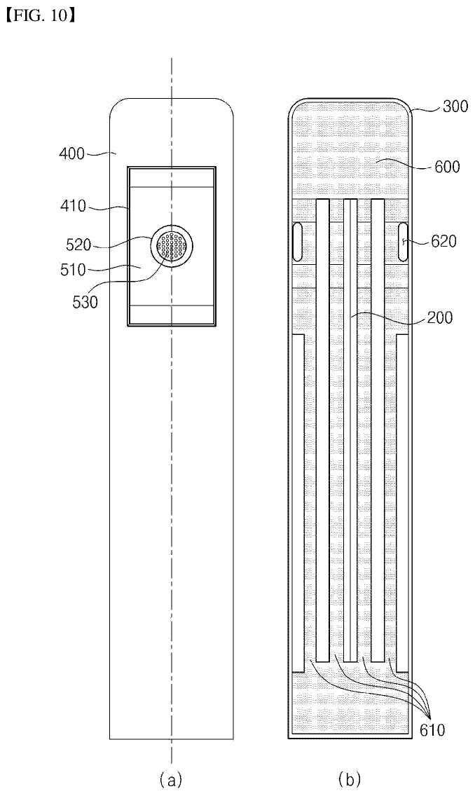

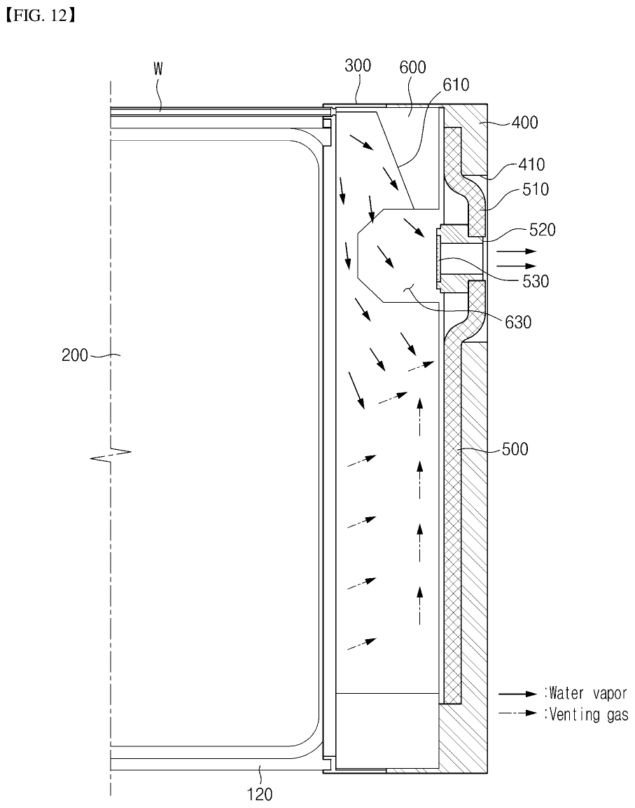

FIG. 10 is a front view illustrating the mounting structure of the guide body 600, wherein a state in which the side cap 400 shown in FIG. 10(a) and the busbar 500 therein are removed is shown in FIG. 10(b). In the embodiment shown, the guide body 600 has a plurality of guide plates 610, whereby the flow of gas generated by the battery cell 200 and coolant and/or water vapor discharged through the spigot hole 320 is divided into a plurality of branches, as shown in FIG. 12. By splitting the flow of gas and coolant into a plurality of branches, the flow is smoother with more even cooling, and the contact area of the gas and coolant is increased, thereby improving the overall cooling efficiency.

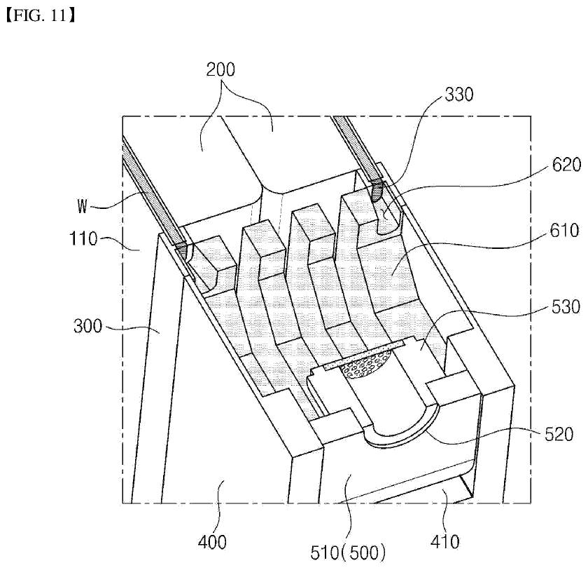

In addition, FIG. 11 is a cross-sectional view cut across the venting hole 520 and the guide body 600, wherein the guide body 600 is closely disposed against the inner surface of the side adapter 300, so that the flow of gas and coolant flows directly into the guide body 600 without scattering. Here, so that the guide body 600 is provided with a through hole 620 corresponding to the spigot hole 320 so that the guide body 600 closely disposed on the inner surface of the side adapter 300 does not block the spigot hole 320.

Meanwhile, when a filter 530 that filters out particles exceeding a certain size is installed in the venting hole 520 of the busbar 500, the guide body 600 may be provided with a storage space 630 formed in the inlet region of the filter 530 in response. The storage space 630 is a space in which the gas and coolant stay for a while just before being discharged, so that sufficient cooling can occur once again between the gas and coolant before being discharged through the filter 530 and the venting hole 520, and serves to alleviate congestion at external discharge.

Here, it may be desirable for the storage space 630 to be disposed downstream of the spigot hole 320 so as not to impede the flow of coolant and/or water vapor discharged from the spigot hole 320.

The present disclosure has been described in more detail above with reference to the drawings and embodiments. However, it is to be understood that the configurations shown in the drawings or embodiments described herein are only one embodiment of the invention and do not represent all of the technical ideas of the invention, and that there may be various equivalents and modifications that may replace them at the time of filing the present application.

### REFERENCE NUMERALS

| | |
|---|---|
| 10: SECONDARY BATTERY | 100: HOUSING |
| 102: HOLLOW PORTION | 104: ENTRANCE/EXIT |
| 110: MAIN HOUSING | 120: BOTTOM PLATE |
| 200: BATTERY CELL | 210: ELECTRODE LEAD |
| 300: SIDE ADAPTER | 310: GROOVE |
| 320: SPIGOT HOLE | 330: STOPPER |
| 400: SIDE CAP | 410: INCISION |
| 500: BUSBAR | 510: ELECTRODE TERMINAL |
| 520: VENTING HOLE | 530: FILTER |
| 600: GUIDE BODY | 610: GUIDE PLATE |
| 620: THROUGH HOLE | 630: STORAGE SPACE |
| W: COOLANT | |

1. A secondary battery, comprising:
a metal housing;
at least one battery cell within the housing; and
a coolant,
wherein the housing comprises an inner surface facing the at least one battery cell and an outer surface spaced apart from the inner surface, and
wherein the coolant is stored in a hollow portion formed between the inner surface and the outer surface.

2. The secondary battery of claim 1, wherein:
the hollow portion is provided with a pair of openings on both sides of the housing.

3. The secondary battery of claim 2, further comprising:
a pair of side adapters on both sides of the housing that seal the pair of openings of the hollow portion.

4. The secondary battery of claim 3, wherein:
the hollow portion is provided in plural,
each of the side adapters includes a groove for coupling to the inner and outer surfaces of the housing, and
the openings of the hollow portions in one side of the housing communicate with each other within the groove.

5. The secondary battery of claim 4, wherein:
each the side adapters includes a spigot hole exposing part of the openings of the hollow portions in one side of the housing to allow for spigotting from the outside, and
the spigot hole is sealed by a stopper.

6. The secondary battery of claim 5, wherein;
the stopper is made of a material having a melting point lower than that of a material of the housing.

7. The secondary battery of claim 6, wherein:
the spigot hole is disposed in the upper part of the housing.

8. The secondary battery of claim 6, further comprising:
a side cap coupled to the side adapter, and forming an interior space in which an electrode lead of the at least one battery cell is located; and
a busbar disposed inside the side cap and electrically connected to the electrode lead, a part of which is exposed through an opening in the side cap forming an electrode terminal.

9. The secondary battery of claim 8, wherein the busbar comprises a venting hole formed on the electrode terminal, and
wherein, when the stopper melts, the coolant and/or water vapor stored in the hollow portion of the housing passes through the spigot hole and is discharged to the venting hole.

10. The secondary battery of claim 9, wherein:
a filter is installed in the venting hole to filter out particles exceeding a pre-determined size.

11. The secondary battery of claim 9, further comprising:
a guide body disposed on an interior of the side cap to face the busbar,
wherein the guide body directs the flow of gases generated by the at least one battery cell, the coolant and/or water vapor discharged through the spigot hole to the venting hole.

12. The secondary battery of claim 11, wherein:
the guide body comprises a plurality of guide plates that divide the flow of gases generated in the at least one battery cell, coolant and/or water vapor discharged through the spigot hole into a plurality of branches.

13. The secondary battery of claim 11, wherein:
the guide body is disposed closely against the inner surface of the side adapter, and is provided with a through hole corresponding to the spigot hole of the side adapter.

14. The secondary battery of claim 11, wherein;
a filter is installed in the venting hole to filter out particles exceeding a pre-determined size, and
the guide body comprises a storage space formed in an inlet region of the filter.

15. The secondary battery of claim 14, wherein:
the storage space is disposed downstream of the spigot hole.
